(19) United States
(12) Patent Application Publication
(10) Pub. No.: US 2024/0116062 A1
(43) Pub. Date: Apr. 11, 2024

(54) SINK WITH EMBEDDED SHOWER HEAD

(71) Applicant: ZHUHAI DALI KITCHEN & BATHROOM TECHNOLOGY CO., LTD., Zhuhai (CN)

(72) Inventors: Jack Chen, Zhuhai (CN); Shuiqing Jiang, Zhuhai (CN); Bocheng Chen, Zhuhai (CN); Xiaoning Huang, Zhuhai (CN)

(21) Appl. No.: 18/389,861

(22) Filed: Dec. 20, 2023

(30) Foreign Application Priority Data
Feb. 23, 2023 (CN) 202320319679.5

(51) Int. Cl. B05B 1/18

(52) U.S. Cl. CPC B05B 1/185

(57) ABSTRACT

Provided is a sink with an embedded shower head. The sink includes a sink main body and a water outlet device, wherein the water outlet device includes a shower head assembly and a switch assembly which are matched with each other. The shower head assembly includes a shower head, a cover plate and a connecting piece. A plurality of water outlet holes are uniformly formed in a surface of the shower head. The cover plate includes a water outlet, the water outlet and the switch assembly are connected through the connecting piece, and the cover plate is closed and installed on the back of the shower head.

### TECHNICAL FIELD

The present disclosure relates to the technical field of sinks, in particular to a sink with an embedded shower head.

### BACKGROUND

The sink is an important hardware product for accommodating water during household cleaning. In the existing market, water used in the conventional sink comes from an independent kitchen faucet, so the rinsing area is small, and much time is spent to complete the cleaning of food. In order to improve the defects in life, the sink with an enlarged spray area exists in the market. The spray module and the kitchen faucet are integrally formed to realize large-area cleaning, but the size of the matchable sink is very limited. At the same time, the faucet is arranged on the top of the sink, so that the top space of the sink is occupied, and articles are inconvenient to take from the sink. In addition, in the process of draining water, the draining basket or draining rack is usually placed outside or on the top of the sink, resulting in occupation of the outer space of the sink and easy collision and dumping.

### SUMMARY

Aiming at the above defects, the technical problem solved by the present disclosure is to provide a universal sink capable of flushing in a wide range, so that the occupation of external space is reduced, articles are convenient to take, and a draining device can be internally installed.

In order to realize the above purpose, the present disclosure provides a sink with an embedded shower head, including a sink main body and a water outlet device, wherein
the water outlet device includes a shower head assembly and a switch assembly which are matched with each other;
the shower head assembly includes a shower head, a cover plate and a connecting piece;
a plurality of water outlet holes are uniformly formed in a surface of the shower head;
the cover plate includes a water outlet, the water outlet and the switch assembly are connected through the connecting piece, and the cover plate is closed and installed on the back of the shower head;
a slot matched with the shower head is formed in a side wall of the sink main body, the shower head is installed in the slot, and the surface of the shower head is flush with a side wall surface of the sink main body; and
a pair of accommodating parts are also arranged on both opposite side walls of the sink main body, and the accommodating parts are located below the slot.

Preferably, the switch assembly is an electrically controlled switch, and the electrically controlled switch controls a water flow through an internal circuit, so that the response is fast, and the reliability is high.

Preferably, the electric control switch includes a touch switch, a solenoid valve assembly and a power supply, and both ends of the solenoid valve assembly are electrically connected with the touch switch and the power supply respectively. The internal circuit can be connected to control the water flow through the touch switch. Wear caused by mechanical operation is avoided, and the sink is intelligent, convenient in operation and more attractive in appearance.

Preferably, the switch assembly is a mechanically controlled switch. The mechanically controlled switch can prevent misoperation to visually display the current state of the switch.

Preferably, the accommodating part is a supporting bar. The supporting bar is formed by protruding the side wall of the sink main body outwards. The supporting bars and the sink main body are integrally formed, so that the sink is attractive in appearance as a whole and the processing technology is simple.

Preferably, the shower head assembly also includes studs and nuts. Through holes matched with the studs are also formed in the cover plate. The studs are installed on the back of the shower head through the through holes. The nuts are in threaded connection with the studs to fix the cover plate on the shower head. Through threaded connection, the cover plate and the shower head are convenient to disassemble and assemble, and damaged accessories are convenient to replace.

The present disclosure has the following beneficial effects.

In the present disclosure, the slot matched with the shower head is formed in the side wall of the sink main body, the shower head is installed in the slot, and the shower head is arranged on the side wall of the sink, so that the space above the sink is wide, and water from the shower head is easy to gather in the sink and unlikely to splash out of the sink. The water outlet holes are uniformly formed in the surface of the shower head to realize large-area cleaning. The surface of the shower head is flush with the side wall surface of the sink main body, so that the internal space of the sink main body is increased, and collision between articles placed or taken out in the sink and the shower head is avoided.

A pair of accommodating parts are also arranged on both opposite side walls of the sink main body. The accommodating parts are located below the slot. A bearing object or a container can be moved on the accommodating parts to wash and clean an internally installed object. A draining rack or a draining basket is arranged on the accommodating parts, that is, water is drained in the sink main body, so that water is convenient to drain, and the draining rack or the draining basket is unlikely to be collided and toppled by external force. At the same time, the occupation of the external space of the sink is reduced.

### BRIEF DESCRIPTION OF THE DRAWINGS

FIG. 1 is a front structural schematic diagram of a sink with an embedded shower head in the first embodiment.

FIG. 2 is an explosive view of a shower head assembly in the first embodiment and the second embodiment.

FIG. 3 is a structural assembly diagram of a shower head assembly in the first embodiment and the second embodiment.

FIG. 4 is a front structural schematic diagram of an electrically controlled switch in the first embodiment.

FIG. 5 is a front structural schematic diagram of a sink with an embedded shower head in the second embodiment.

### DETAILED DESCRIPTION OF THE EMBODIMENTS

The following clearly and completely describes the technical solutions in the embodiments of this application with reference to the attached figures in the embodiments of this application. Apparently, the described embodiments are merely some but not all of the embodiments of the present disclosure. All other embodiments obtained by those skilled in the art based on the embodiments of the present disclosure without creative efforts shall fall within the protection scope of the present disclosure.

In the description of the present disclosure, it needs to be illustrated that the indicative direction or position relations of the terms such as “left”, “right”, “middle”, “front” and “rear” are direction or position relations illustrated based on the accompanying diagrams, just for facilitating the description of the present disclosure, but not for demanding that the present disclosure must be constructed and operated in the specific direction, the terms cannot be understood as the restriction of the present disclosure.

In the description of the present disclosure, the terms such as “first” and “second” are just used for distinguishing the description, but cannot be understood to indicate or hint relative importance.

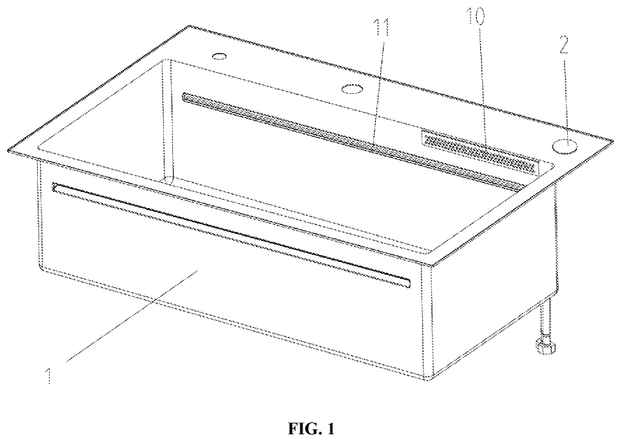

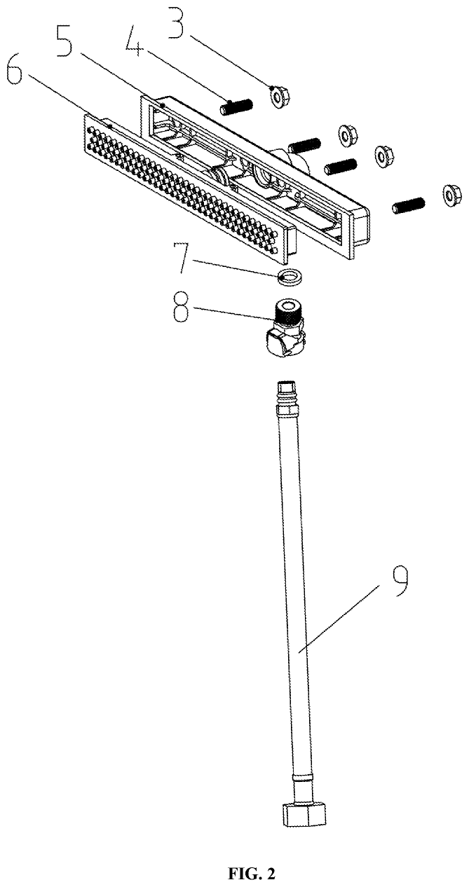

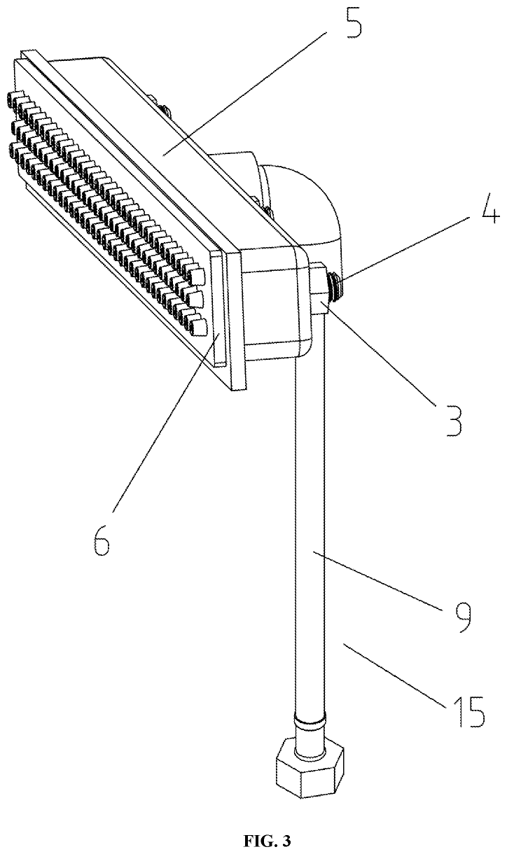

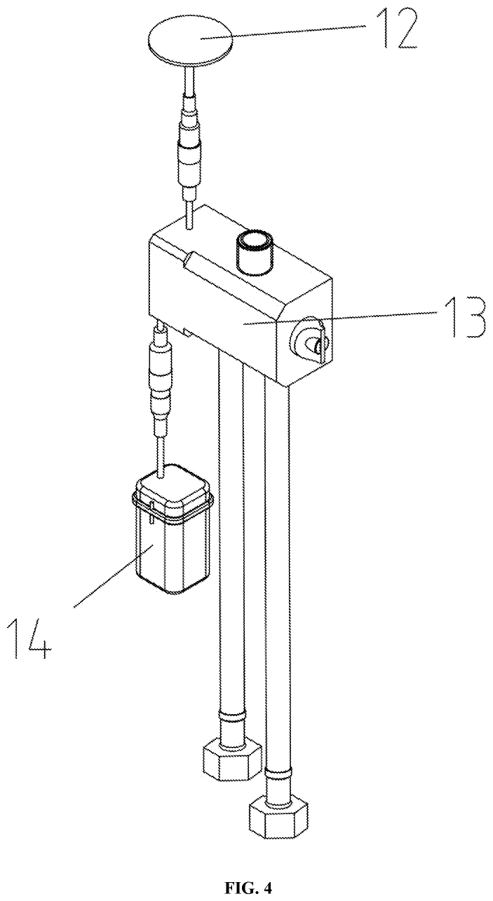

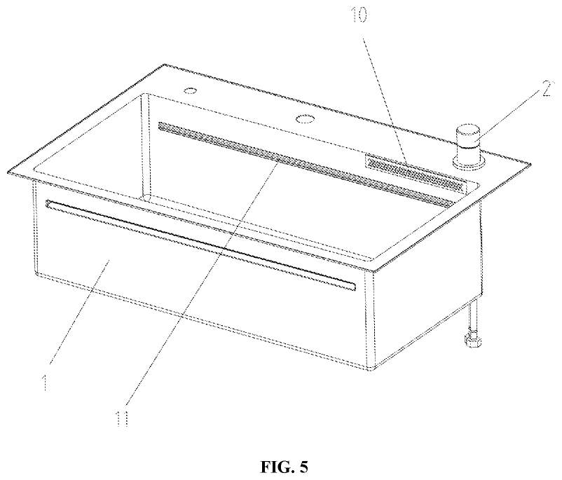

FIG. 1 is a front structural schematic diagram of a sink with an embedded shower head in the first embodiment. FIG. 2 is an explosive view of a shower head assembly in the first embodiment and the second embodiment. FIG. 3 is a structural assembly diagram of a shower head assembly in the first embodiment and the second embodiment. FIG. 4 is a front structural schematic diagram of an electrically controlled switch in the first embodiment. FIG. 5 is a front structural schematic diagram of a sink with an embedded shower head in the second embodiment.

Reference signs in the figures: 1, sink main body; 2, electrically controlled switch; 2′, mechanically controlled switch; 3, nut; 4, stud; 5, cover plate; 6, shower head; 7, plane rubber mat; 8, connector; 9, connecting hose; 10, shower head assembly; 11, supporting bar; 12, touch switch; 13, solenoid valve assembly; 14, power supply; and 15, connecting piece.

An installation and using method of a sink with an embedded shower head provided by the present disclosure includes the following steps:
firstly, installing a shower head 6 in a slot;
secondly, installing studs 4 on the shower head 6 through through holes in a cover plate 5, enabling nuts 3 to be in threaded connection with the studs 4, and fixing the cover plate 5 on the shower head 6;
thirdly, connecting a water outlet with a switch assembly through a connecting piece 15;
fourthly, controlling a water outlet manner of the water flow by the switch assembly;
fifthly, placing a bearing object or a container on accommodating parts, and flushing an internally installed object of the bearing object or the container; and
sixthly, placing a draining device on the accommodating parts for draining.

### Embodiment I

The first embodiment provides a sink with an embedded shower head. The sink includes a sink main body 1 and a water outlet device, wherein the water outlet device includes a shower head assembly 10 and a switch assembly which are matched with each other. The switch assembly is an electrically controlled switch 2 and includes a touch switch 12, a solenoid valve assembly 13 and a power supply 14, and both ends of the solenoid valve assembly 13 are electrically connected with the touch switch 12 and the power supply 14 respectively. The shower head assembly 10 includes a shower head 6, a cover plate 5, studs 4, nuts 3 and a connecting piece 15. A plurality of water outlet holes are uniformly formed in a surface of the shower head 6. The cover plate 5 includes through holes matched with the studs 4 and a water outlet, the studs 4 are installed on the back of the shower head 6 through the through holes, the nut 3 is in threaded connection with the stud 4, and the cover plate 5 is fixed on the back of the shower head 6. The connecting piece 15 includes a plane rubber mat 7, a connector 8 and a connecting hose 9, the connector 8 is in threaded connection with the water outlet, the plane rubber mat 7 is installed between the connector 8 and the water outlet, and both ends of the connecting hose 9 are in threaded connection with the connector 8 and the solenoid valve assembly 13 respectively. A slot matched with the shower head 6 is formed in a side wall of the sink main body 1, the shower head 6 is installed in the slot, and the surface of the shower head 6 is flush with a side wall surface of the sink main body 1. A pair of accommodating parts are also arranged on both opposite side walls of the sink main body 1, the accommodating part is a supporting bar 11 formed by protruding the side wall of the sink main body 1 inwards, and the accommodating parts 11 are located below the slot.

In the first embodiment, the slot matched with the shower head 6 is formed in the side wall of the sink main body 1, the shower head 6 is installed in the slot, and the shower head 6 is arranged on the side wall of the sink, so that the space above the sink is wide, and water from the shower head 6 is easy to gather in the sink and unlikely to splash out of the sink. The water outlet holes are uniformly formed in the surface of the shower head 6 to realize large-area cleaning. The surface of the shower head 6 is flush with the side wall surface of the sink main body 1, so that the internal space of the sink main body 1 is increased, and collision between articles placed or taken out in the sink and the shower head 6 is avoided.

A pair of supporting bars 11 formed by protruding the side wall of the sink main body 1 outwards are also arranged on both opposite side walls of the sink main body 1, the supporting bars 11 are located below the slot, and the supporting bars 11 and the sink main body 1 are integrally formed, so that the sink is attractive in appearance as a whole and the processing technology is simple. A bearing object or a container can be moved on the supporting bars 11 to wash and clean an internally installed object. A draining rack or a draining basket is arranged on the supporting bars 11, that is, water is drained in the sink main body 1, so that water is convenient to drain, and the draining rack or the draining basket is unlikely to be collided and toppled by external force. At the same time, the occupation of the external space of the sink is reduced.

The electrically controlled switch 2 can be connected with an internal circuit to control the water flow through the touch switch, so that the response is fast, the reliability is high, wear caused by mechanical operation is avoided, and the sink is intelligent, convenient in operation and more attractive in appearance.

The cover plate 5 and the shower head 6 are fixed through threaded connection, and are convenient to disassemble and assemble. Damaged accessories are convenient to replace.

### Embodiment II

The second embodiment provides a sink with an embedded shower head. The sink includes a sink main body 1 and a water outlet device, wherein the water outlet device includes a shower head assembly 10 and a switch assembly which are matched with each other. The switch assembly is a mechanically controlled switch 2′. The shower head assembly 10 includes a shower head 6, a cover plate 5, studs 4, nuts 3 and a connecting piece 15. A plurality of water outlet holes are uniformly formed in a surface of the shower head 6. The cover plate 5 includes through holes matched with the studs 4 and a water outlet, the studs 4 are installed on the back of the shower head 6 through the through holes, the nut 3 is in threaded connection with the stud 4, and the cover plate 5 is fixed on the back of the shower head 6. The connecting piece 15 includes a plane rubber mat 7, a connector 8 and a connecting hose 9, the connector 8 is in threaded connection with the water outlet, the plane rubber mat 7 is installed between the connector 8 and the water outlet, and both ends of the connecting hose 9 are in threaded connection with the connector 8 and the mechanically controlled switch 2′ respectively. A slot matched with the shower head 6 is formed in a side wall of the sink main body 1, the shower head 6 is installed in the slot, and the surface of the shower head 6 is flush with a side wall surface of the sink main body 1. A pair of accommodating parts are also arranged on both opposite side walls of the sink main body 1, the accommodating part is a supporting bar 11 formed by protruding the side wall of the sink main body 1 inwards, and the accommodating parts 11 are located below the slot.

In the second embodiment, the slot matched with the shower head 6 is formed in the side wall of the sink main body 1, the shower head 6 is installed in the slot, and the shower head 6 is arranged on the side wall of the sink, so that the space above the sink is wide, and water from the shower head 6 is easy to gather in the sink and unlikely to splash out of the sink. The water outlet holes are uniformly formed in the surface of the shower head 6 to realize large-area cleaning. The surface of the shower head 6 is flush with the side wall of the sink main body 1, so that the internal space of the sink main body 1 is increased, and collision between articles placed or taken out in the sink and the shower head 6 is avoided.

A pair of supporting bars 11 formed by protruding the side wall of the sink main body 1 outwards are also arranged on both opposite side walls of the sink main body 1, the supporting bars 11 are located below the slot, and the supporting bars 11 and the sink main body 1 are integrally formed, so that the sink is attractive in appearance as a whole and the processing technology is simple. A bearing object or a container can be moved on the supporting bars 11 to wash and clean an internally installed object. A draining rack or a draining baAsket is arranged on the supporting bars 11, that is, water is drained in the sink main body 1, so that water is convenient to drain, and the draining rack or the draining basket is unlikely to be collided and toppled by external force. At the same time, the occupation of the external space of the sink is reduced.

The mechanically controlled switch 2′ can prevent misoperation to visually display the current state of the switch.

The cover plate 5 and the shower head 6 are fixed through threaded connection, and are convenient to disassemble and assemble. Damaged accessories are convenient to replace.

The embodiments disclosed above are described to enable a technical person skilled in the art to implement or use the present disclosure. Various modifications to the embodiments are obvious to those skilled in the art, and general principles defined in the present disclosure may be implemented in other embodiments without departing from the spirit or scope of the present disclosure. Therefore, the present disclosure will not be limited to the embodiments described in the present disclosure but extends to the widest scope that complies with the principles and novelty disclosed in the present disclosure.

What is claimed is:

1. A sink with an embedded shower head, comprising a sink main body and a water outlet device, wherein
the water outlet device comprises a shower head assembly and a switch assembly which are matched with each other;
the shower head assembly comprises a shower head, a cover plate and a connecting piece;
a plurality of water outlet holes are uniformly formed in a surface of the shower head;
the cover plate comprises a water outlet, the water outlet and the switch assembly are connected through the connecting piece, and the cover plate is closed and installed on the back of the shower head;
a slot matched with the shower head is formed in a side wall of the sink main body, the shower head is installed in the slot, and the surface of the shower head is flush with a side wall surface of the sink main body; and
a pair of accommodating parts are also arranged on both opposite side walls of the sink main body, and the accommodating parts are located below the slot.

2. The sink with an embedded shower head according to claim 1, wherein the switch assembly is an electrically controlled switch.

3. The sink with an embedded shower head according to claim 2, wherein the electric control switch comprises a touch switch, a solenoid valve assembly and a power supply, and both ends of the solenoid valve assembly are electrically connected with the touch switch and the power supply respectively.

4. The sink with an embedded shower head according to claim 1, wherein the switch assembly is a mechanically controlled switch.

5. The sink with an embedded shower head according to claim 1, wherein the accommodating part is a supporting bar, and the supporting bar is formed by protruding the side wall of the sink main body inwards.

6. The sink with an embedded shower head according to claim 1, wherein the shower head assembly also comprises studs and nuts, through holes matched with the studs are also formed in the cover plate, the studs are installed on the back of the shower head through the through holes, and the nuts are in threaded connection with the studs to fix the cover plate on the shower head.
